(19) United States
(12) Patent Application Publication
(10) Pub. No.: US 2004/0167795 A1
(43) Pub. Date: Aug. 26, 2004

(54) Method and system for processing business process, and processing program therefor

(76) Inventors: Akira Tanaka, Yokohama (JP); Akiko Ogawa, Tokyo (JP)

Correspondence Address: MATTINGLY, STANGER & MALUR, P.C., 1800 DIAGONAL ROAD, SUITE 370, ALEXANDRIA, VA, 22314, US

(21) Appl. No.: 10/650,688

(22) Filed: Aug. 29, 2003

(30) Foreign Application Priority Data
Feb. 25, 2003 (JP) 2003-046684

(51) Int. Cl. G06F 17/60

(52) U.S. Cl. 705/1; 705/7

(57) ABSTRACT

The present invention relates to a method for managing a business process in a network environment. Heretofore, a special control computer node that is provided performs the business-process management. However, since the business-process management is performed in a centralized manner, there are issues like a management load becomes high, business is not realized on equal terms, and the business process is forced to be executed without allowing contents of the whole business process to be understood. The present invention has been made to solve these problems.

In the method for managing a business process in a network environment according to the present invention, business process definitions are described in the standard XML language, and the business process definitions are passed together with information required for the step to computer nodes that execute each step of the business process. Consequently, the computers can execute the business process by operating on equal terms, and also by understanding the context of the business process. As for an execution status of the business process, monitoring is also implemented by providing a monitoring node which updates the progress status of he business process by collecting success/failure reports from each node involved in the business process.

### FIELD OF THE INVENTION

The present invention relates to a technology for processing a workflow and a business process.

### DESCRIPTION OF THE RELATED ART

As found in the standardization of workflow technologies and in various kinds of products in which the standard is realized, business-process control has been conventionally implemented as an application of a workflow technology. In this method, to begin with, a user defines a business process. Then, on the basis of the definitions, and by use of a communication means such as remote procedure call (RPC) or message sending, a software component which is called a workflow engine sends to software, or a person, having a responsibility for an individual step a request for successively processing steps or work according to the business process definitions. As a result, the business process is executed, and the progress of the business process is monitored accordingly.

In addition, it is known that the standardization of description methods using the XML language is being argued in the field of business process definitions. However, they merely prescribe grammar rules for descriptions, and therefore how to use a described definition document is not prescribed.

Moreover, in the technology as disclosed in Japanese Patent Laid-open No. 9-265408, a similar angle was targeted in the sense of the decentralized execution of a workflow. Here, the technology is characterized by the following: \mathring{1} the technology relates to automation of a workflow on a document base rather than automation of a business process itself; and \mathring{2} the technology is based on the assumption that workflow definitions to be transmitted include not only flow information but also a program, and that the program is executed in each node. The technology, therefore, differs from the present invention in various points of view (its targeted field, technical elements, etc.). The points of difference, which are described in claims of this patent, include: implementation of the execution of a “business process” by passing a XML “document” where human operation is not premised; dynamic detection of a step-execution entity; transfer by referring to document information and message information; and settings of a monitoring node used for monitoring the progress of the business process.

In the above-mentioned prior art, centralized control and management are performed by a control component that is called a workflow engine. Accordingly, the technology requires software and hardware, reliability of which is high, and which are designed specifically for the centralized control and management.

Moreover, in a business process extending across the boundary between companies, the master/slave relationship is not appropriate. Therefore, it is necessary to execute the business process by associating each company's system with the other on equal terms.

Furthermore, because it is so devised that an entity which executes steps executes processing by use of only minimum supplied information required for the execution, the execution entity is not supplied with information enough to judge, for example, whether or not it should accept the request from the viewpoint of business.

An objective of the present invention is to implement the execution framework of a business process in a distributed processing environment in a decentralized manner.

### SUMMARY OF THE INVENTION

In order to solve the above-mentioned problems, there is provided a means for successively passing, between steps, business-process definitions described in a standard document description language, and information required for the execution of a business process, by use of a function of message sending. With this method, it becomes possible to accomplish each step processing by allowing participating computer nodes to operate on equal terms, and also to understand context of the business process, without requiring a control node.

There is also provided a node used for monitoring the progress of business-process processing, toward which the result will be notified when the step processing ends. Provision of this monitoring node enables not only monitoring of the progress but also performing of appropriate action in the event a failure occurs in the step processing.

### BRIEF DESCRIPTION OF DRAWINGS

FIG. 1 is a diagram illustrating a system configuration used when a cloth processing package business process system is implemented using a method according to one embodiment of the present invention;

FIG. 2 illustrates an example of cloth processing package business process definitions written in the XML language, which are referred to in FIG. 1;

FIG. 3 illustrates an example of a part of document for purchasing cloth material shown in FIG. 1;

FIG. 4 illustrates an example of a part of document for manufacturing clothing items shown in FIG. 1;

FIG. 5 illustrates an example of a part of document for manufacturing nonclothing items shown in FIG. 1;

FIG. 6 illustrates an example of a part of document for package shown in FIG. 1;

FIG. 7 illustrates an example of a message transmitted, to a node, together with a business-process definition document;

FIG. 8 illustrates an example of a processing flow in each step-execution computer node, which is referred to in FIG. 1;

FIG. 9 illustrates an example of components of each step-execution computer node, which is referred to in FIG. 1; and

FIG. 10 is a diagram illustrating a configuration example of business that executes, for another, management functions such as starting, monitoring, and ending in the example of the business process referred to in FIG. 1.

### DESCRIPTION OF THE PREFFERRED EMBODIMENTS

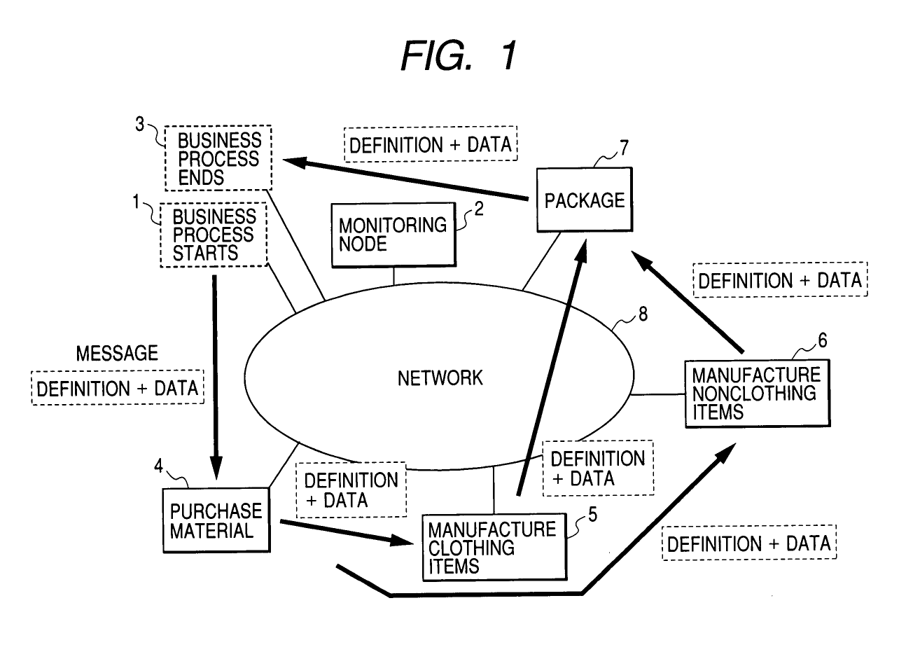

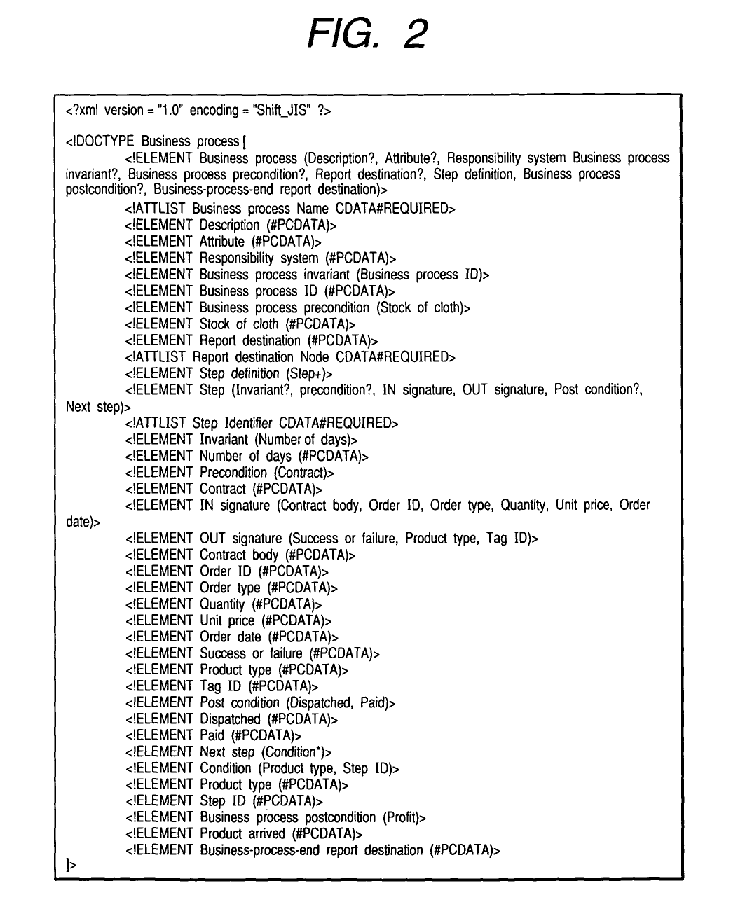

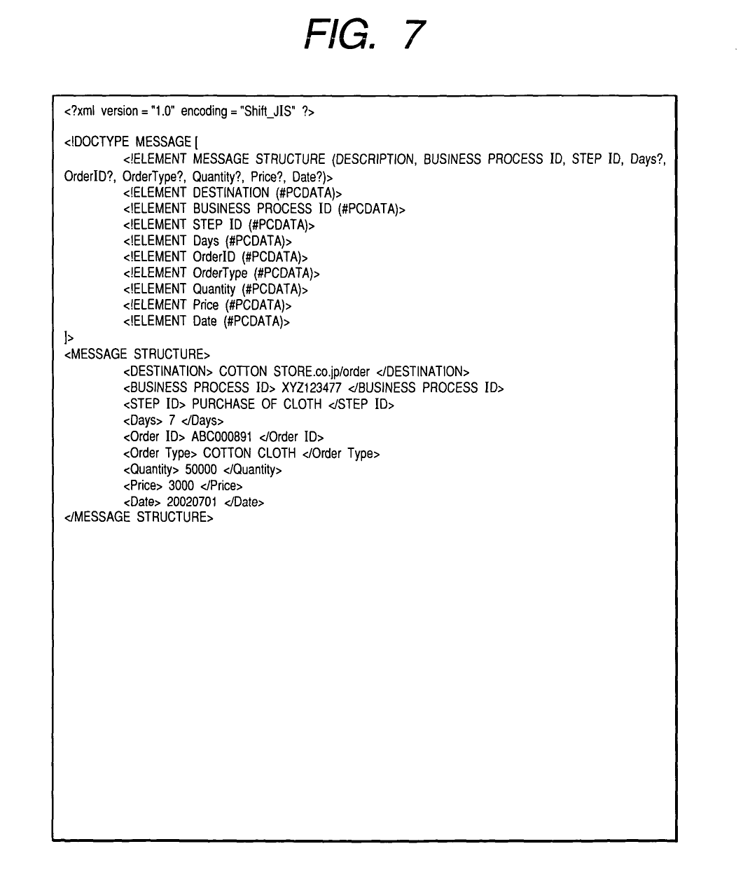

An embodiment of the present invention will be described below with reference to the accompanying drawings. FIG. 1 is a diagram illustrating a configuration according to one embodiment of the present invention. This embodiment shows seven computer nodes that are connected over a network 8. A business-process starting node 1 starts a business process. A step to be executed first in this business process is a cloth material purchasing step. The business-process starting node 1 transmits to a cloth-material-purchasing-step execution node 4 a business-process definition document illustrated in FIGS. 2 through 6 as well as a message shown in FIG. 7. After the cloth material purchasing step ends, according to conditions specified in the business-process definition document in FIG. 7, the business-process definition document illustrated in FIGS. 2 through 6, and a similar message including required information like the one shown in FIG. 7, are transmitted to either a clothing-item-manufacturing-step execution node 5 or a nonclothing-item-manufacturing-step execution node 6. It is to be noted that a message format used here conforms to a format which is opened to the public by each step execution node. The instant that the processing in these steps ends, the business-process definition document illustrated as examples in FIGS. 2 through 6, and a similar including required information like the one shown in FIG. 7, are transmitted from either the clothing-item-manufacturing-step execution node 5 or the nonclothing-item-manufacturing-step execution node 6 to a packaging-step execution node 7. If the processing in the packaging-step execution node successfully ends, the business process ends, and subsequently a report is transmitted to a business-process-end reporting node.

The instant that processing in each step successfully ends, a notification message is transmitted to the business-process monitoring node 2 in order to enable the monitoring of the progress of the business process. If a problem arises in processing in a certain step, the business-process monitoring node 2 performs appropriate action, such as compensation operation, on each of the step execution nodes that has already reported the normal end.

Here, the three nodes, i.e., the business-process starting node 1, the business process monitoring node 2, and the business-process-end reporting node 3, may be placed on the same computer; or each of the nodes may also be placed on a separate computer.

Incidentally, instead of directly transmitting the business-process definition document itself as part of a message, the following method may also be applied: storing the business-process definition document in an accessible location in the network, and transmitting a message including location information such as a URL so that the business-process definition document can be accessed using an access method that refers to the location information.

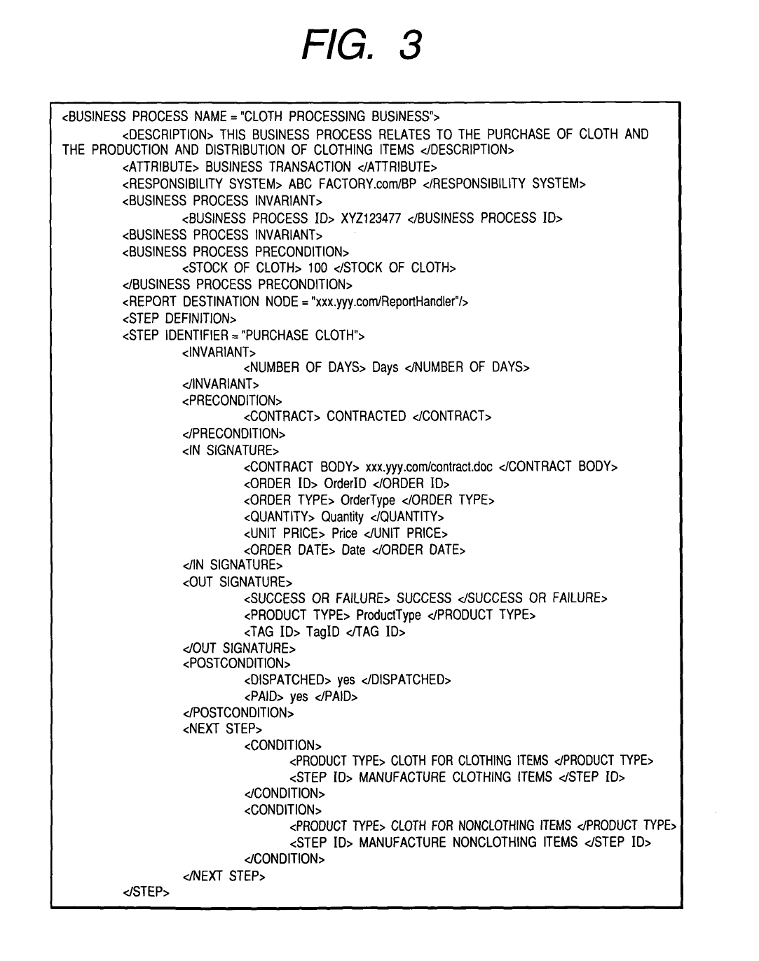

FIGS. 2 through 6 illustrate examples that define this business process as XML documents. Although an example in which a description is given in the XML language is shown in the present invention, a description means used is not limited to the XML language. As long as the description means can provide a capability for defining data structure that enables a description from a structural point of view, any description means can be applied. Although a message transferred between programs is used as a document and is expressed as such here, a message in a narrow sense, or a request, can also serve for the same purpose. FIG. 2 illustrates a document structure in which a business process comprises a description, an attribute, a responsibility system, a business process invariant, a business process precondition, a report destination, a step definition, and a business process postcondition. Additionally, a plurality of steps can be defined in the document structure. Moreover, FIG. 2 shows that the step has elements of an invariant, a precondition, a signature, a postcondition, and a next step. FIGS. 3 through 6 illustrate examples how business processes are specifically defined.

FIG. 7 illustrates an example of a message transmitted, to a step, together with a business-process definition document. In the figure, a destination specifies a computer and an application which execute a step. Next, a business process ID and a step 1D identify a step in a business process where the processing should be performed. Subsequent data are parameters required for step execution. From the viewpoint of safety, the message itself may also be encrypted by use of PKI, etc.

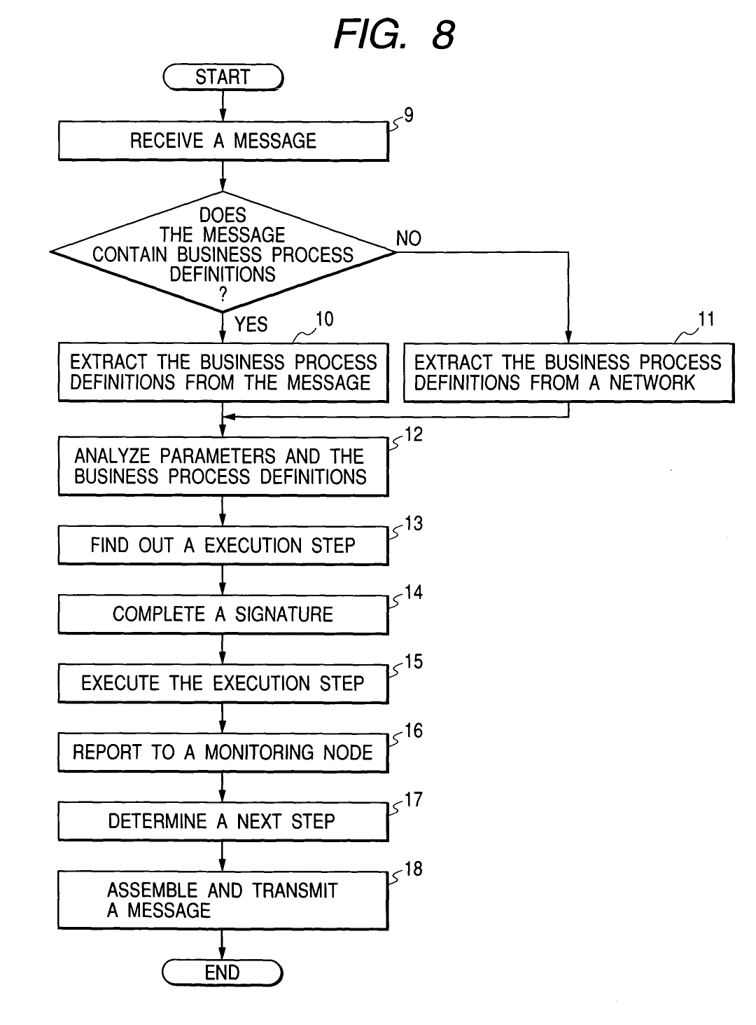

FIG. 8 illustrates an example of a process flow in each computer node that participates in the execution of a business process. First, a message is received in reference numeral 9. If the message contains a business definition document, the document is extracted in reference numeral 10. On the other hand, if the message does not contain the business definition document, the document is obtained via a network according to URL information as shown in reference numeral 11, and the business definition document is then analyzed by referring to the parameter information contained in the message in reference numeral 12. On the basis of the result, a step to be executed is detected in the business process definitions in reference numeral 13, and thereby a signature which is input information required for the processing is created in reference numeral 14. Consequently, the processing is executed in reference numeral 15. Its result is reported to the monitoring node in reference numeral 16. Judging from conditions included in the step definitions, a step to be executed next is determined in reference numeral 17. Lastly, a message to be passed to the next step is made in reference numeral 18, and then the message is transmitted to a step-execution computer node that executes the step that has determined in reference numeral 17.

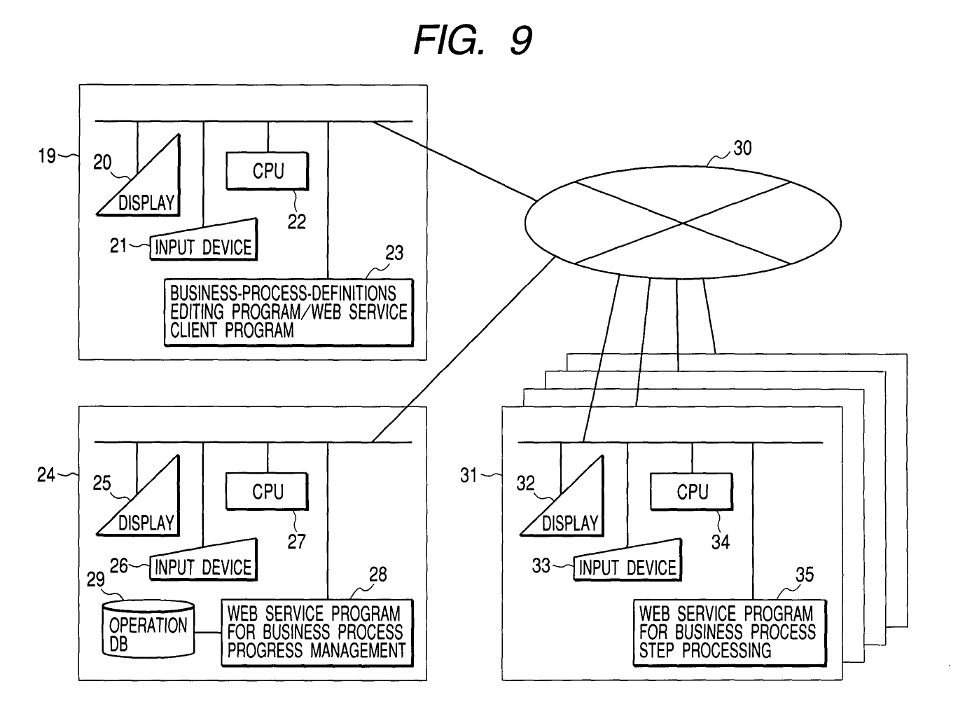

FIG. 9 illustrates an example of how a system and devices are configured in order to implement the business-process processing method. Reference numeral 19 is an example of a business-process user system, which comprises a display 20, an input device 21, and a CPU 22. A user of the business-process user system 19 uses this system to create a business-process definition document, and also to issue an execution request to a business-process step execution device 31, by executing the business-process-definition editing program and the Web service client program 23. Reference numeral 24 is a configuration example of a business process monitor, which comprises a display 25, an input device 26, and a CPU 27. The business process monitor executes a business-process progress management Web service program 28, and thereby receives the execution result from the business-process step execution device 31 at any time. This enables the user to monitor the progress through the business-process user system 19, or the like. In addition, a table of operations to be performed, which is obtained from the business process user, is stored beforehand in a DB 29. If the business process monitor receives the result stating that the business process could not be executed, it is possible to instruct compensation operation by reading out a corresponding entry. Reference numeral 31 is a configuration example of a business-process step execution device, which comprises a display 32, an input device 33, and a CPU 34. This device executes a business-process step processing Web service program 35, and thereby a step described in the business process definition can be executed accordingly. It is to be noted that the system 19 and the devices 24, 31 are connected via the network 30 where open communication is possible.

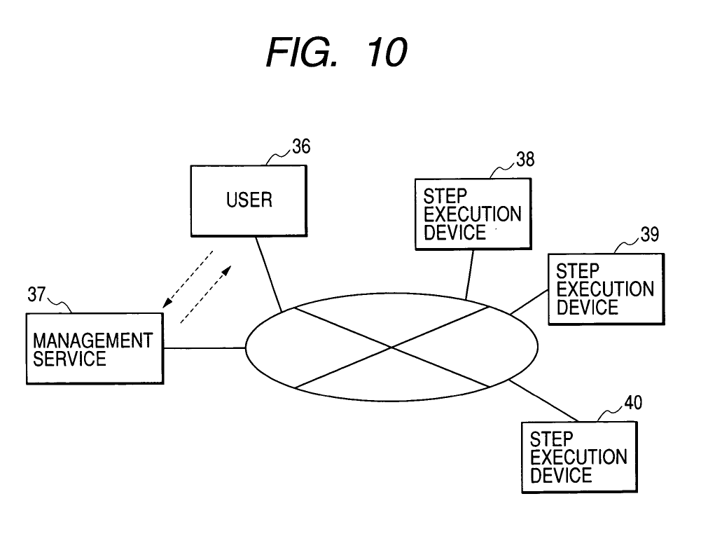

FIG. 10 illustrates an example of a business method which uses the business-process processing method and the business-process processing device, and in which the progress of a business process is monitored, and as the need arises, starting of compensation operation, for instance, is executed for another to cope with the need. The business process user 36 defines a business process, and then requests a business-process processing service provider 37 to execute the business process. The business-process processing service provider takes the place of the business process user 36 as a requester, and therefore transmits as a message a business-process definition document as well as parameter information required for step processing to a step execution device 38 that executes a starting step of the business process. After the step processing ends, the step execution device 38 transmits a message to step execution devices 39, 40 using the method as mentioned in the description of FIG. 1. In this case, after each step processing ends, result information such as processing end and processing impossible is transmitted to the business-process processing service provider 37. However, in the case of processing failure, another business process which is equivalent to compensation action may also be issued from the business-process processing service provider 37. The business-process processing service provider 37 obtains the counter value by providing the user with a service of business process management.

Operation of the programs according to the present invention will be described below using some examples.

1 Operation of Business-Process Starting Program

1.1 Premises

1) Before the execution of the business-process starting program, business process definitions (XML document) are created in one of the following manners:

a definition document that includes all values (example: a service executor name, and all parameter values to be passed)—an executor of a business process, parameters and the like are all fixed, and accordingly no change is allowed during the business process (this is based on the assumption that a mechanism for proving that no change is made (for example, encryption and a digital signature) is used in combination);

a definition document that is partially parameterized (example: a document in which various kinds of information to be passed to the service executor are parameterized)—this is based on the assumption that the step execution result is passed to the next step as part of the business process definition; and

a definition document in which all variable elements are parameterized so that the definition document can be used as a template (example: a typical purchasing process)—a library, or a repository, of business process definition templates is provided beforehand, and the library or the repository is searched for a base template, which is then instantiated for use.

2) The above-mentioned business process definitions are used in the forms of: \mathring{1} input data that is passed to the business-process starting program; or \mathring{2}parameterized or template data stored in the business process definition repository (DB), instantiated for its use by parameter setting.

1.2 Description of Processing Logic on the Basis of Example

1) A business process XML definition document is read.

2) The business process XML definition document is parsed.

3) <description> is displayed on a window (corresponding to line 2 of FIG. 3, a message “This business process relates to the purchase of cloth and the production and distribution of clothing items.” is displays on a display unit).

4) <attribute> is checked whether or not the attribute is a business transaction (the attribute corresponds to “business transaction” in line 3 of FIG. 3).

5) <responsibility system> is checked whether or not the responsibility system agrees with a system name of a system that starts this business process execution (the responsibility system corresponds to “ABC factory.com/BP” in line 4 of FIG. 3).

6) A check is made as to whether or not <business process ID> is included as <business process invariant> (this corresponds to “XYZ123477” in lines 5 through 7 of FIG. 3).

7) If <business process ID> is set, the business process ID is stored as an ID of this business process (if <business process ID> is not set, the business-process starting program generates a unique value, and then sets this value).

8) A value (100) of <stock of cloth> in <business process precondition> is compared with the actual amount of stock (read out from the information base by the starting program), and then a check is made as to whether or not the actual amount of stock is 100 or less (this corresponds to “100” in lines 8 through 10 of FIG. 3).

9) If <report destination> is set, this is stored as a report destination in this business process (if <report destination> is not set, an address of a responsibility system is set here) (this corresponds to “xxx.yyy.com/ReportHandler” in line 11 of FIG. 3).

10) A check is made as to whether or not <step definition> exists (this corresponds to line 12 of FIG. 3).

11) An identifier (service name) which is an attribute of <step> appearing first is stored (this corresponds to “purchase cloth” in line 13 of FIG. 3 and also “purchase cloth” in line 18 of FIG. 7).

12) On the basis of the stored identifier, a step executor is selected.

Selection by the name service (in the case of a system name having a specific identifier)

Selection by the UDDI (if an identifier is a service name, the service is searched for by accessing the UDDI, and thereby a service provider satisfying a select-on criterion is selected).

13) Parameters to be passed to the step executor is prepared.

If <invariant> is <number of days>, a specific value of the <number of days> is given as <Days> to the message to be transmitted together with the business process definition. However, if the responsibility system specifies a numerical value from the beginning, nothing is done (“7” in line 19 of FIG. 7 corresponding to lines 14 through 16 of FIG. 3).

Also as for <order ID>, a specific value of the <order ID> is given as <OrderID> to the message to be transmitted together with the business process definition. However, if the responsibility system specifies a numerical value from the beginning, nothing is done (“ABC000891” in line 20 of FIG. 7 corresponding to line 22 of FIG. 3).

Also as for <order type>, a specific value of the <order type> is given as <OrderType> to the message to be transmitted together with the business process definition. However, if the responsibility system specifies a numerical value from the beginning, nothing is done (“Cotton cloth” in line 21 of FIG. 7 corresponding to line 23 of FIG. 3).

Also as for <quantity>, a specific value of the <quantity>is given as <Quantity> to the message to be transmitted together with the business process definition. However, if the responsibility system specifies a numerical value from the beginning, nothing is done (“50000” in line 22 of FIG. 7 corresponding to line 24 of FIG. 3).

Also as for <unit price>, a specific value of the <unit price> is given as <Price> to the message to be transmitted together with the business process definition. However, if the responsibility system specifies a numerical value from the beginning, nothing is done (“3000” in line 23 of FIG. 7 corresponding to line 25 of FIG. 3).

Also as for <order date>, a specific value of the <order date> is given as <Date> to the message to be transmitted together with the business process definition. However, if the responsibility system specifies a numerical value from the beginning, nothing is done (this corresponds to “20020701” in line 26 of FIG. 3).

14) A message to be transmitted to the selected service provider is created as below (main items are specified in FIG. 7).

Header part

Sending system name: responsibility system name

Business process ID: business process ID

Destination system name: name of selected service provider

Step name: step identifier

Monitoring system name: reporter name

Content part

XML document having a list formed of (name, value) of <Days>, <OrderID>, <OrderType>, <Quantity>, <Price>, <Date> (for a case where <number of days>, <order ID>, <order type>, <quantity>, <unit price>, <order date> from which the list is originated are not specified by the responsibility system)

The above-mentioned business process definition XML document (or its URL)

15) This message is transmitted to the selected service provider.

16) The business process document is transmitted to the monitoring system, and notifies the monitoring system that the business process has started.

2 Operation of Programs in Clothing Material Purchasing Step

2.1 Premises

1) A message is Received.

2) The message is analyzed, and then each information in the header part and each information in the content part are stored (the contents specified in FIG. 7).

3) Using a step name included in the header part, a corresponding step is determined from the business process definitions in the content part (in the example, cloth purchasing step) (information in line 13 of FIG. 3 is used).

4) If the step execution cannot be accepted, the monitoring node is notified accordingly.

2.2 Description of Processing Logic on the Basis of Example

1) As far as a value (“Days”) of <number of days> in <invariant> is concerned, because <Days> is specified in the messaged, the “Days” is replaced by a value of the <Days> before storing it (this corresponds to line 15 of FIG. 3, and is equivalent to the replacement by the value in line 19 of FIG. 7).

2) Also as for <order ID>, <order type>, <quantity>, <unit price>, and <order date>, they are respectively replaced by the respective values of <OrderID>, <OrderType>, <Quantity>, <Price>, and <Date> in a similar manner before storing them (this corresponds to lines 22 through 26 of FIG. 3 and lines 20 through 24 of FIG. 7).

3) A check is made as to whether or not a value (contracted) of <contract> in <precondition> agrees with contract-related information between the step executor and the responsibility system (this information is read out from the information base) (this corresponds to descriptive contents of “xxx.yyy.com/contract.doc” in line 21 of FIG. 3).

4) Starting of an application is prepared.

<IN signature> information, which becomes parameters when starting the application, is set (this corresponds to lines 20 through 27 of FIG. 3).

Contract body: a document, an URL, or the like, is set.

Order ID: a value specified in <OrderID> is set.

Order type: a value specified in <OrderType> is set.

Quantity: a value specified in <Quantity> is set.

Unit price: a value specified in <Price> is set.

Order date: a value specified in <Date> is set.

5) The application is started to obtain a return (result), and then <OUT signature> information is set (this corresponds to lines 28 through 32 of FIG. 3).

Success or failure: the success or failure indicates whether or not the application processing has ended successfully (this corresponds to line 29 of FIG. 3).

Product type: a type of a product produced as a result of the application processing (this corresponds to line 30 of FIG. 3).

Tag ID: an identifier provided when the product is passed to a subsequent step (this corresponds to line 31 of FIG. 3).

6) A check is made as to whether or not the value of <success or failure> is success; in the case of failure, a failure report message is transmitted to a reporter without executing processing thereafter.

7) A check is made as to whether or not the value (yes) of <dispatched> in <postcondition> agrees with a <dispatched> status (read from the information base) in this business process (identified by ID) of the step executor (this corresponds to line 34 of FIG. 3).

8) A check is made as to whether or not the value (yes) of <paid> in <postcondition> agrees with a <paid> status (read from the information base) in this business process (identified by ID) of the step executor (this corresponds to line 35 of FIG. 3).

9) Next step is determined.

If a value of <product type> in the return from the starting of the application agrees with <product type> that exists in <condition> of <next step>, a value of <step 1D> in the next line becomes the next step 1D (lines 39 and 43 of FIG. 3 are the conditions, and next step IDs are lines 40 and 44 respectively).

In this example, if a product type is cloth for clothing items, the next step is a step of clothing item manufacturing. On the other hand, if a product type is cloth for nonclothing items, the next step is a step of nonclothing item manufacturing. This shows how the transition to the next step is made.

10) According to the above-mentioned judgment, an identifier (service name) which is an attribute of the determined step is read out from the business-process definition XML document.

11) On the basis of the identifier, a step executor is selected.

Selection by the name service (in the case of a system name having a specific identifier)

Selection by the UDDI (if an identifier is a service name, the service is searched for by the UDDI, and thereby a service provider satisfying a selection criterion is selected).

12) Parameters to be passed to the step executor are prepared.

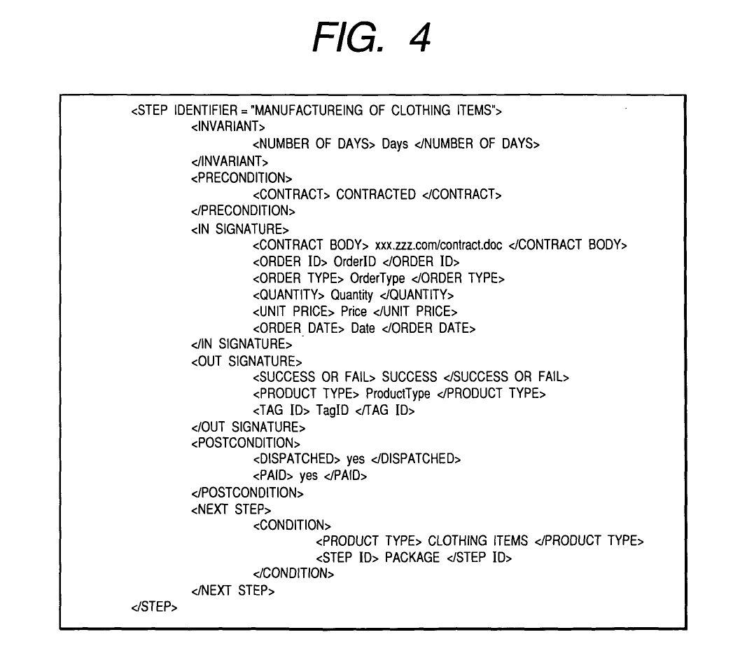

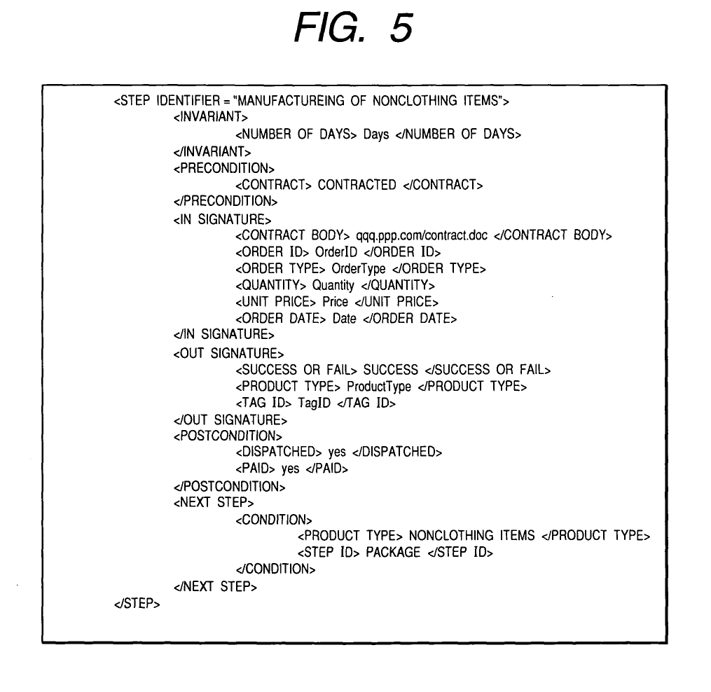

If <invariant> is <number of days>, a specific value of the <number of days> is given as <Days> to the message to be transmitted together with the business process definitions. However, if the responsibility system specifies a numerical value from the beginning, nothing is done (line 19 of FIG. 7 corresponding to line 3 of FIG. 4 or line 3 of FIG. 5).

Also as for <order ID>, a specific value of the <order ID> is given as <OrderID> to the message to be transmitted together with the business process definitions. However, if the responsibility system specifies a numerical value from the beginning, nothing is done (line 20 of FIG. 7 corresponding to line 10 of FIG. 4 or line 10 of FIG. 5).

Also as for <order type>, a specific value of the <order type> is given as <OrderType> to the message to be transmitted together with the business process definitions. However, if the responsibility system specifies a numerical value from the beginning, nothing is done (line 21 of FIG. 7 corresponding to line 11 of FIG. 4 or line 11 of FIG. 5).

Also as for <quantity>, a specific value of the <quantity> is given as <Quantity> to the message to be transmitted together with the business process definitions. However, if the responsibility system specifies a numerical value from the beginning, nothing is done (line 22 of FIG. 7 corresponding to line 12 of FIG. 4 or line 12 of a FIG. 5).

Also as for <unit price>, a specific value of the <unit price> is given as <Price> to the message to be transmitted together with the business process definitions. However, if the responsibility system specifies a numerical value from the beginning, nothing is done (line 23 of FIG. 7 corresponding to line 13 of FIG. 4 or line 13 of FIG. 5).

Also as for <order date>, a specific value of the <order date> is given as <Date> to the message to be transmitted together with the business process definitions. However, if the responsibility system specifies a numerical value from the beginning, nothing is done (line 24 of FIG. 7 corresponding to line 14 of FIG. 4 or line 14 of FIG. 5).

13) A message to be transmitted to the selected service provider is created as below (main items are specified in FIG. 7).

Header part

Sending system name: responsibility system name

Business process ID: business process ID

Destination system name: name of selected service provider

Step name: step identifier

Monitoring system name: reporter name

Content part

XML document having a list formed of (name, value) of <Days>, <OrderID>, <OrderType>, <Quantity>, <Price>, <Date> (for a case where <number of days>, <order ID>, <order type>, <quantity>, <unit price>, <order date> from which the list is originated are not specified by the responsibility system)

The above-mentioned business process definition XML document (or its URL)

14) The monitoring system is notified that the clothing material purchasing step of this business process has finished. Then, this message is transmitted to the selected service provider.

3 Clothing Item Manufacturing Step

3.1 Premises

1) A message is received.

2) The message is analyzed, and then each information in the header part and each information in the content part are stored.

3) Using a step name included in the header part, a corresponding step is determined from the business process definitions in the content part (in the example, the clothing item manufacturing step) (this corresponds to “Manufacturing of clothing item” in line 1 of FIG. 4).

4) As the need arises, an inquiry is sent to the monitoring node to check that the last step has already finished successfully.

5) If the step execution cannot be accepted, the monitoring node is notified accordingly.

3.2 Description of Processing Logic by Way of Example

1) As far as a value (“Days”) of <number of days> in <invariant> is concerned, because <Days> is specified in the message, the “Days” is replaced by a value of the <Days> before storing it (this corresponds to line 2 through 4 of FIG. 4).

2) Also as for <order ID>, <order type>, <quantity>, <unit price>, and <order date>, they are replaced by the respective values of <OrderID>, <OrderType>, <Quantity>, <Price>, and <Date> in a similar manner before storing them (this corresponds to lines 10 through 14 of FIG. 4).

3) A check is made as to whether or not a value (contracted) of <contract> in <precondition> agrees with contract-related information between the step executor and the responsibility system (this information is read out from the information base) (this corresponds to descriptive contents of “xxx.yyy.com/contract.doc” in line 9 of FIG. 4).

4) Starting of an application is prepared.

<IN signature> information, which becomes parameters when starting the application, is set (this corresponds to lines 8 through 15 of FIG. 4).

Contract body: a document, an URL, or the like, is set.

Order ID: a value specified in <OrderID> is set.

Order type: a value specified in <OrderType> is set.

Quantity: a value specified in <Quantity> is set.

Unit price: a value specified in <Price> is set.

Order date: a value specified in <Date> is set.

5) The application is started to obtain a return (result), and then <OUT signature> information is set (this corresponds to lines 16 through 20 of FIG. 4).

Success or failure: the success or failure indicates whether or not the application processing has ended successfully (this corresponds to line 17 of FIG. 4).

Product type: a type of a product produced as a result of the application processing (this corresponds to line 18 of FIG. 4).

Tag ID: an identifier provided when the product is passed to a subsequent step (this corresponds to line 19 of FIG. 4).

6) A check is made as to whether or not the value of <success or failure> is success; in the case of failure, a failure report message is transmitted to a reporter without executing processing thereafter.

7) A check is made as to whether or not the value (yes) of <dispatched> in <postcondition> agrees with a <dispatched>status (read from the information base) in this business process (identified by ID) of the step executor (this corresponds to line 22 of FIG. 4).

8) A check is made as to whether or not the value (yes) of <paid> in <postcondition> agrees with a <paid> status (read from the information base) in this business process (identified by ID) of the step executor (this corresponds to line 23 of FIG. 4).

9) Next step is determined.

If a value of <product type> in the return from the starting of the application agrees with <product type> that exists in <condition> of <next step>, a value of <step 1D> in the next line becomes the next step 1D (line 27 of FIG. 4 is the condition, and line 28 is the next step)

In this example, if a product type is clothing items, the next step is a package step. This shows how the transition to the next step is made.

10) According to the above-mentioned judgment, an identifier (service name) which is an attribute of the determined step is read out from the business-process definition XML document.

11) On the basis of the identifier, a step executor is selected.

Selection by the name service (in the case of a system name having a specific identifier)

Selection by the UDDI (if an identifier is a service name, the service is searched for by the UDDI, and thereby a service provider satisfying a selection criterion is selected).

12) Parameters to be passed to the step executor are prepared.

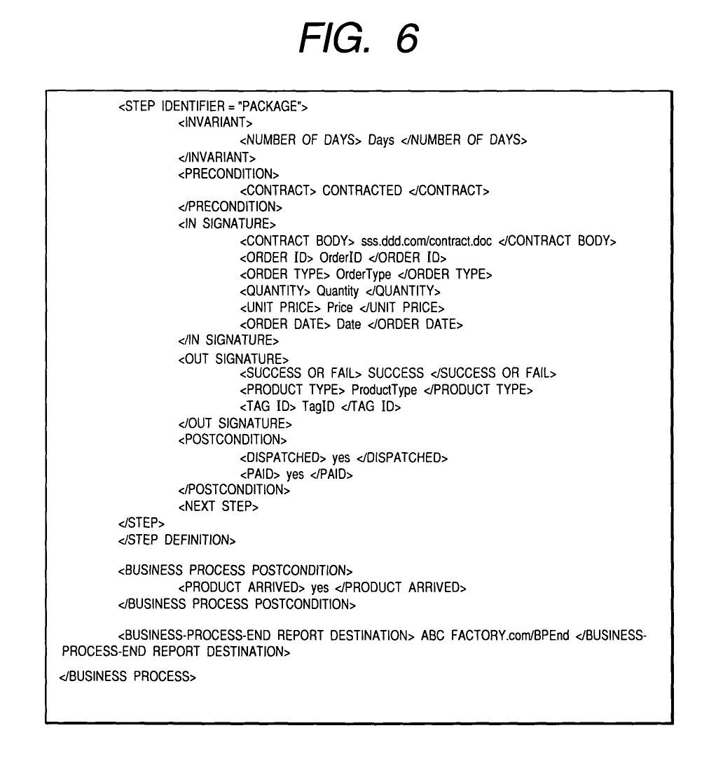

If <invariant> is <number of days>, a specific value of the <number of days> is given as <Days> to the message to be transmitted together with the business process definitions. However, if the responsibility system specifies a numerical value from the beginning, nothing is done (line 19 of FIG. 7 corresponding to line 3 of FIG. 6).

Also as for <order ID>, a specific value of the <order ID> is given as <OrderID> to the message to be transmitted together with the business process definitions. However, if the responsibility system specifies a numerical value from the beginning, nothing is done (line 20 of FIG. 7 corresponding to line 10 of FIG. 6).

Also as for <order type>, a specific value of the <order type> is given as <OrderType> to the message to be transmitted together with the business process definitions. However, if the responsibility system specifies a numerical value from the beginning, nothing is done (line 21 of FIG. 7 corresponding to line 11 of FIG. 6).

Also as for <quantity>, a specific value of the <quantity> is given as <Quantity> to the message to be transmitted together with the business process definitions. However, if the responsibility system specifies a numerical value from the beginning, nothing is done (line 22 of FIG. 7 corresponding to line 12 of FIG. 6).

Also as for <unit price>, a specific value of the <unit price> is given as <Price> to the message to be transmitted together with the business process definitions. However, if the responsibility system specifies a numerical value from the beginning, nothing is done (line 23 of FIG. 7 corresponding to line 13 of FIG. 6).

Also as for <order date>, a specific value of the <order date> is given as <Date> to the message to be transmitted together with the business process definitions. However, if the responsibility system specifies a numerical value from the beginning, nothing is done (line 24 of FIG. 7 corresponding to line 14 of FIG. 6).

13) A message to be transmitted to the selected service provider is created as below (main items are specified in FIG. 7).

Header part

Sending system name: responsibility system name

Business process ID: business process ID

Destination system name: name of selected service provider

Step name: step identifier

Monitoring system name: reporter name

Content part

XML document having a list formed of (name, value) of <Days>, <OrderID>, <OrderType>, <Quantity>, <Price>, <Date> (for a case where <number of days>, <order ID>, <order type>, <quantity>, <unit price>, <order date> from which the list is originated are not specified by the responsibility system)

The above-mentioned business process definition XML document (or its URL)

14) The monitoring system is notified that the clothing material manufacturing step of this business process has finished. Then, this message is transmitted to the selected service provider.

4 Nonclothing Item Manufacturing Step

4.1 Premises

1) A message is received.

2) The message is analyzed, and then each information in the header part and each information in the content part are stored.

3) Using a step name included in the header part, a corresponding step is determined from the business process definitions in the content part (in the example, the nonclothing item manufacturing step) (this corresponds to “Manufacturing of nonclothing item” in line 1 of FIG. 5).

4) As the need arises, an inquiry is sent to the monitoring node to check that the last step has already finished successfully.

5) If the step execution cannot be accepted, the monitoring node is notified accordingly.

4.2 Description of Processing Logic on the Basis of Example

1) As far as a value (“Days”) of <number of days> in <invariant> is concerned, because <Days> is specified in the message, the “Days” is replaced by a value of the <Days> before storing it (this corresponds to line 2 though 4 of FIG. 5).

2) Also as for <order ID>, <order type>, <quantity>, <unit price>, and <order date>, they are replaced by the respective values of <OrderID>, <OrderType>, <Quantity>, <Price>, and <Date> in a similar manner before storing them (this corresponds to lines 10 through 14 of FIG. 5).

3) A check is made as to whether or not a value (contracted) of <contract> in <precondition> agrees with contract-related information between the step executor and the responsibility system (this information is read out from the information base) (this corresponds to descriptive contents of “qqq.ppp.com/contract.doc” in line 9 of FIG. 5).

4) Starting of an application is prepared.

<IN signature> information, which becomes parameters when starting the application, is set (this corresponds to lines 8 through 15 of FIG. 5).

Contract body: a document, an URL, or the like, is set.

Order ID: a value specified in <OrderID> is set.

Order type: a value specified in <OrderType> is set.

Quantity: a value specified in <Quantity> is set.

Unit price: a value specified in <Price> is set.

Order date: a value specified in <Date> is set.

5) The application is started to obtain a return (result), and then <OUT signature> information is set (this corresponds to lines 16 through 20 of FIG. 5).

Success or failure: the success or failure indicates whether or not the application processing has ended successfully (this corresponds to line 17 of FIG. 5).

Product type: a type of a product produced as a result of the application processing (this corresponds to line 18 of FIG. 5).

Tag ID: an identifier provided when the product is passed to a subsequent step (this corresponds to line 19 of FIG. 5).

6) A check is made as to whether or not the value of <success or failure> is success; in the case of failure, a failure report message is transmitted to a reporter without executing processing thereafter.

7) A check is made as to whether or not the value (yes) of <dispatched> in <postcondition> agrees with a <dispatched> status (read from the information base) in this business process (identified by ID) of the step executor (this corresponds to line 22 of FIG. 5).

8) A check is made as to whether or not the value (yes) of <paid> in <postcondition> agrees with a <paid> status (read from the information base) in this business process (identified by ID) of the step executor (this corresponds to line 23 of FIG. 5).

9) Next step is determined.

If a value of <product type> in the return from the starting of the application agrees with <product type> that exists in <condition> of <next step>, a value of <step 1D> in the next line becomes the next step 1D (line 27 of FIG. 5 is the condition, and line 28 is the next step)

In this example, if a product type is nonclothing items, the next step is a package step. This shows how the transition to the next step is made.

10) According to the above-mentioned judgment, an identifier (service name) which is an attribute of the determined step is read out from the business-process definition XML document.

11) On the basis of the identifier, a step executor is selected.

Selection by the name service (in the case of a system name having a specific identifier)

Selection by the UDDI (if an identifier is a service name, the service is searched for by the UDDI, and thereby a service provider satisfying a selection criterion is selected)

12) Parameters to be passed to the step executor are prepared.

If <invariant> is <number of days>, a specific value of the <number of days> is given as <Days> to the message to be transmitted together with the business process definitions. However, if the responsibility system specifies a numerical value from the beginning, nothing is done (line 19 of FIG. 7 corresponding to line 3 of FIG. 6).

Also as for <order ID>, a specific value of the <order ID> is given as <OrderID> to the message to be transmitted together with the business process definitions. However, if the responsibility system specifies a numerical value from the beginning, nothing is done (line 20 of FIG. 7 corresponding to line 10 of FIG. 6).

Also as for <order type>, a specific value of the <order type> is given as <OrderType> to the message to be transmitted together with the business process definitions. However, if the responsibility system specifies a numerical value from the beginning, nothing is done (line 21 of FIG. 7 corresponding to line 11 of FIG. 6).

Also as for <quantity>, a specific value of the <quantity> is given as <Quantity> to the message to be transmitted together with the business process definitions. However, if the responsibility system specifies a numerical value from the beginning, nothing is done (line 22 of FIG. 7 corresponding to line 12 of FIG. 6).

Also as for <unit price>, a specific value of the <unit price> is given as <Price> to the message to be transmitted together with the business process definitions. However, if the responsibility system specifies a numerical value from the beginning, nothing is done (line 23 of FIG. 7 corresponding to line 13 of FIG. 6).

Also as for <order date>, a specific value of the <order date> is given as <Date> to the message to be transmitted together with the business process definitions. However, if the responsibility system specifies a numerical value from the beginning, nothing is done (line 24 of FIG. 7 corresponding to line 14 of FIG. 6).

13) A message to be transmitted to the selected service provider is created as below (main items are specified in FIG. 7).

Header part

Sending system name: responsibility system name

Business process ID: business process ID

Destination system name: name of selected service provider

Step name: step identifier

Monitoring system name: reporter name

Content part

XML document having a list formed of (name, value) of <Days>, <OrderID>, <OrderType>, <Quantity>, <Price>, <Date> (for a case where <number of days>, <order ID>, <order type>, <quantity>, <unit price>, <order date> from which the list is originated are not specified by the responsibility system)

The above-mentioned business process definition XML document (or its URL)

14) The monitoring system is notified that the nonclothing material purchasing step of this business process has finished. Then, this message is transmitted to the selected service provider.

5 Package Step

5.1 Premises

1) A message is received.

2) The message is analyzed, and then each information in the header part and each information in the content part are stored.

3) Using a step name included in the header part, a corresponding step is determined from the business process definitions in the content part (in the example, the package step) (this corresponds to “Package” in line 1 of FIG. 6).

4) As the need arises, an inquiry is sent to the monitoring node to check that the last step has already finished successfully.

5) If the Step Execution cannot be Accepted, the Monitoring Node is Notified Accordingly.

5.2 Description of Processing Logic on the Basis of Example

1) As far as a value (“Days”) of <number of days> in <invariant> is concerned, because <Days> is specified in the message, the “Days” is replaced by a value of the <Days> before storing it (this corresponds to line 3 though 5 of FIG. 6).

2) Also as for <order ID>, <order type>, <quantity>, <unit price>, and <order date>, they are replaced by values of <OrderID>, <OrderType>, <Quantity>, <Price>, and <Date> in a similar manner before storing them (this corresponds to lines 10 through 14 of FIG. 6).

3) A check is made as to whether or not a value (contracted) of <contract> in <precondition> agrees with contract-related information between the step executor and the responsibility system (this information is read out from the information base) (this corresponds to line 9 of FIG. 6).

4) Starting of an application is prepared.

<IN signature> information, which becomes parameters when starting the application, is set (this corresponds to lines 8 through 15 of FIG. 6).

Contract body: a document, an URL, or the like, is set.

Order ID: a value specified in <OrderID> is set.

Order type: a value specified in <OrderType> is set.

Quantity: a value specified in <Quantity> is set.

Unit price: a value specified in <Price> is set.

Order date: a value specified in <Date> is set.

5) The application is started to obtain a return (result), and then <OUT signature> information is set (this corresponds to lines 16 through 20 of FIG. 6).

Success or failure: the success or failure indicates whether or not the application processing has ended successfully (this corresponds to line 17 of FIG. 6).

Product type: a type of product produced as a result of the application processing (this corresponds to line 18 of FIG. 6).

Tag ID: an identifier provided when the product is passed to a subsequent step (this corresponds to line 19 of FIG. 6).

6) A check is made as to whether or not the value (yes) of <dispatched> in <postcondition> agrees with a <dispatched> status (read from the information base) in this business process (identified by ID) of the step executor (this corresponds to line 22 of FIG. 6).

7) A check is made as to whether or not the value (yes) of <paid> in <postcondition> agrees with a <paid> status (read from the information base) in this business process (identified by ID) of the step executor (this corresponds to line 23 of FIG. 6).

8) Next Step is Determined.

If a value of <product type> in the return from the starting of the application agrees with <product type> that exists in <condition> of <next step>, a value of <step 1D> in the next line becomes the next step 1D (this corresponds to line 26 of FIG. 6).

Because there is no information about the next step in this example, the business process ends, and then the transition to the business-process-end report destination is made (this corresponds to line 31 of FIG. 6).

9) A message to be transmitted to the selected service provider is created as below (main items are specified in FIG. 7).

Header part

Sending system name: responsibility system name

Business process ID: business process ID

Destination system name: business-process ending program

Step name: Not described

Monitoring system name: reporter name

Content part

XML document having a list formed of (name, value) of <Days>, <OrderID>, <OrderType>, <Quantity>, <Price>, <Date> (for a case where <number of days>, <order ID>, <order type>, <quantity>, <unit price>, <order date> from which the list is originated are not specified by the responsibility system)

The above-mentioned business process definition XML document (or its URL)

10) The monitoring system is notified that this business process has ended. Then, this message is transmitted to the business-process ending program.

6 Operation of Business-Process-End Report Destination

1) A message is received.

2) The message is analyzed, and then each information in the header part and each information in the content part are stored.

3) A business-process end message is given to an operator.

7 Operation of Business-Process Monitoring Program

1) A case where a success report message is received

The progress of each step in the business process is stored as business-process execution history information.

2) A case where an inquiry about the progress is received

The progress of each step, which is stored, is returned.

3) A case where a failure report message is received

The responsibility system is notified of the failure, and a new business process is started to execute predetermined compensation operation, etc.

4) A case where a step-execution failure message is received

If a step executor is identified in the business-process definition document, processing used when a failure report message is received is performed. If a step executor is not identified, an alternative step execution node is detected by use of a dynamic discovery mechanism such as the UDDI, and then a request to continue the business process is sent to the node.

According to the present invention described above, the business process can be executed on equal terms and in a decentralized manner in a network environment. In addition, by sharing business process definitions, it is possible for each node to understand business contents before judging whether or not to participate in the execution of the business process.

Moreover, by providing a monitoring node, it is possible to monitor the progress of the business process, the execution of which progresses in a decentralized manner. Further, control processing used for an error which occurs during the execution of the business process can also be provided by use of this monitoring node.

In addition, if data needs to be passed between computer nodes that execute each step of the business process, instead of merely transmitting a message including the data, which is one of methods for passing the data, it is also possible to pass the data by transmitting a message that uses the URL notation, or the like, and that includes only a location of the data and an access method accordingly.

Moreover, as regards the method for identifying each step-execution computer node in a flow of the business process, only a service name and service contents may be described in the business-process definition document. By using a dynamic discovery mechanism for discovering a Web service that uses UDDI, or the like, at the time of the execution, it is possible to identify a service execution computer node, which meets the service requirements.

Furthermore, it is shown that as an action, executing management of the business process, an user's behalf can be realized as business.

As described above, according to the present invention, the execution of the business process in a distributed processing environment can be achieved in a decentralized manner.

What is claimed is:

1. A method for processing a business process by a plurality of computers in cooperation with one another, said plurality of computer being capable of intercommunication, said method comprising the steps of:
referring to a message including a business process definition to generate an input parameter to be passed to a next step as a logical message, and transmitting the logical message to a computer for executing the next step; and
by said computer, executing the step and also analyzing information included in the business process definition to determine a next step to be executed, generating, as a logical message, an input parameter to be passed to the next step, said input parameters having been generated by the processing of the business-process definition message, and transmitting the logical message to a computer node for executing the next step.

2. A method for processing a business process according to claim 1, wherein notifying a predetermined monitoring node of the execution result in the step permits the progress of the business process to be known at any time, and if the business process cannot proceed to a subsequent node due to the occurrence of a failure, the business process is interrupted by the monitoring node, and then a business process which implements compensation operation is started, on the basis of the definition.

3. A method for managing a business process according to claim 1, wherein, if data needs to be passed between steps, the data is included as part of a message to be passed between the steps, or a location and an identifier of the data, and an access method for accessing the data are included as part of the business process message.

4. A method for managing a business process according to claim 1, wherein, when identifying a step-execution entity in the business process definitions, a next step-execution entity is discovered or determined by specifying a system name or specifying type information including a service name and service description so that a network address can be directly obtained by name resolution.

5. A system and an apparatus that execute a decentralized business process by use of the method for processing a business process according to any one of claims 1 through 4.

6. A business method of taking a load of a business process initiator, comprising the steps of:
by use of the device according to claim 5 and the method for processing a business process according to any one of claims 1 through 5,
receiving a request from another;
monitoring progress of a business process; and
starting operations including an compensation operation as the need arises.

7. A system for processing a business process by a plurality of computers in cooperation with one another, said plurality of computer being capable of intercommunication, said system comprising:
means for referring to a message including a business process definition to generate input parameters to be passed to a next step as a logical message, and then transmitting the logical message to a computer for executing the next step; and
means for, by said computer, executing the step and also analyzing information included in the business process definition to determine a next step to be executed, generating, as a logical message, an input parameter to be passed to the next step, said input parameter having been generated by the processing of the business-process definition message, and transmitting the logical message to a computer node for executing the next step.

8. A business-process processing program used for a system for processing a business process by a plurality of computers in cooperation with one another, said plurality of computer being capable of intercommunication, said business-process processing program comprising the functions of:
referring to a message including a business process definition to generate an input parameter to be passed to a next step as a logical message, and then transmitting the logical message to a computer for executing the next step; and
by said computer, executing the step and also analyzing information included in the business process definition to determine a next step to be executed, subsequently generating, as a logical message, an input parameter to be passed to the next step, said input parameters having been generated by the processing of the business-process definition message, and transmitting the logical message to a computer node for executing the next step.
